(19) United States
(12) Patent Application Publication
(10) Pub. No.: US 2005/0027570 A1
(43) Pub. Date: Feb. 3, 2005

(54) Digital image collection and library system

(76) Inventors: Frith Ann Maier, Burien, WA (US); Brian Theodore Povolny, Burien, WA (US); Jerome Robert Baruffi, Bellevue, WA (US); Dmitriy Mirkarimov, Kent, WA (US)

Correspondence Address: BRIAN M BERLINER, ESQ;O'MELVENY & MYERS, LLP, 400 SOUTH HOPE STREET, LOS ANGELES, CA, 90071-2899, US

(21) Appl. No.: 10/837,374

(22) Filed: Apr. 30, 2004

Related U.S. Application Data
(63) Continuation-in-part of application No. 09/637,138, filed on Aug. 11, 2000.

(51) Int. Cl. G06F 17/60; G06F 7/00; G06F 17/00

(52) U.S. Cl. 705/3; 707/104.1; 382/305

(57) ABSTRACT

Collection, access and management of controlled-access digital image data across disparate image data protocols from different sources, for example, clinical-quality and communicative-quality images of all types used in the practice of medicine, is achieved using a digital image collection and library system over a wide area network. The system includes a database connectivity module configured for automatic uploading of image data from image repositories employing data protocols of various types for image data, in association with subject data. A central library system manages distribution and control of collected images to qualified requesters.

### RELATED APPLICATION

This application is a continuation-in-part of co-pending application Ser. No. 09/637,138, filed Aug. 11, 2000, which application is incorporated herein, in its entirety, by reference.

### BACKGROUND OF THE INVENTION

1. Field of the Invention

The present invention relates to methods and systems for collection, access and management of controlled-access digital image data across disparate image data protocols from different sources, for example, clinical-quality and communicative-quality images of all types used in the practice of medicine, using a wide area network.

2. Description of Related Art

Certain processes involve the collection and management of image data in disparate image data protocols and from different sources, and distribution of such image data to qualified recipients. For example, in the health care field, different health care providers, laboratory technicians, and the like, may create different images all relating to the same patient. Such images may be taken at different times, using different imaging methods and image data protocols, and may relate to different subject areas, while all relating to the same patient. For example, in health care applications, images may comprise photographs, x-rays, tomagrams, catscans, MRI's videos, animations, and modeled data in different data protocols, such as various forms of digital data, film, paper and magnetic media, having the essential quality of graphically representing a view or related views of an actual or modeled subject. It should be apparent that images, as such, are generally capable of being displayed on essentially two-dimensional media such as paper, film, and electronic displays, although often encompassing three-dimensional information about the subject.

It is often desirable to share disparate images concerning a single subject with different persons. For example, various different images from different sources may be of interest to persons involved in the health care of the same individual. At the same time, it is desirable to protect and securely store the images. Similar image-collection and controlled distribution problems may also arise in other industries, for example, production of entertainment programs and works of art, in litigation, in police work, and in research and development applications. Indeed, a wide array of creative and/or analytical processes may benefit from the collection and controlled distribution of images in different data protocols and from different sources.

Prior art solutions for the collection and controlled access to such image data suffer from numerous limitations. In the health care field, an individual's health care is often provided by numerous independent doctors and other providers that lack a unified system for collecting and sharing image data. No universal standard exists for sharing medical image data. Digital transmission of images in controlled contexts is not unknown, but is generally confined to limited image subsets with limited or no ability for collecting images under a broad and expandable range of image protocols and image collection protocols. Consequently, images are usually shared the old-fashioned way, such as by physically carrying or mailing film or prints from provider to provider. In the process, the images may be prone to being damaged or lost. Plus, such processes can be very inefficient and slow, compared to more modern methods. Perhaps worse still, images may be transmitted using ad hoc, unsecured transmission methods, which may create the potential for serious breaches of confidentiality obligations.

In theory, virtually every type of image can be converted to a suitable digital format and readily distributed over a computer network, such as the internet. In practice, however, this is not so easily achieved. For example, in a field such as medicine that involves an ever-evolving multitude of different imaging technologies, the prior art has not enabled collecting and distributing imaging data in a broad and expandable range of digital data protocols. Different medical providers often lack the know-how and other resources required to provide images in network-compatible format. Nor can standardization readily solve the problem, if at all, because of the rapidly evolving technology in medical imaging and the availability of competing digital data protocols, many of which are proprietary to particular imaging hardware and/or software applications.

It is desirable, therefore, to provide a system and method for the collection and management of image data in disparate data protocols and from different sources, and distribution of such image data to qualified recipients, that overcomes the limitations of the prior art.

### SUMMARY OF THE INVENTION

The invention overcomes the limitations of the prior art, and provides for more efficient sharing of image data. It does not rely on control of image data protocols, and is designed to accommodate collection and distribution of digital image data in any defined digital protocol, with distribution controlled and limited to qualified recipients authorized for viewing the image data. The invention may be used in conjunction with, or as an integrated portion, of systems and methods for managing personal data in health care and analogous contexts, such as presented more fully in the parent application. In the alternative, the system and method may be used in a stand-alone mode. The invention should be particularly useful for handling image data in health care contexts, but is not limited to such contexts.

Advantageously, the invention may be configured to collect image data from imaging data sources, such as servers that store and/or process image data in user-determined data protocols, without requiring the installation of specialized application software on such servers. Such operating modes may sometimes be referred to as “zero-footprint,” in that software specific to the invention need not be installed on the network-connected terminals that provide image data to the system, nor on terminals where the images are viewed. A typical end-user may access and view images using standard network resources, such as web-browsing software, in conjunction with distributed applets, templates, and other network objects that, if necessary, may be provided on-demand from an image server or other network location.

Another advantage provided by the invention comprises the automatic management of image quality according to the intended end use. Such management may include, for example, the preservation of high-quality, high-bandwidth image data when the application demands it, and conversely, translation to lower-quality formats to minimize bandwidth requirements, when appropriate.

Management of image quality may be regarded as an aspect of managing disparate image data protocols, more generally. The ability to accept images in disparate data protocols from different users, and to distribute images in appropriate data protocols to different clients, is an extremely desirable end result that prior-art systems have failed to achieve over a broadly defined and readily expandable range of digital data protocols. The invention can achieve these desirable results in very complex and demanding environment, such as health-care imaging, by making use of a unified imaging sub-system that is structured in a scaleable and flexible manner.

In an embodiment of the invention, the unified imaging sub-system comprises cooperating components, herein labeled for convenience an image-source liaison component and an image library component. The image-source liaison component may be configured to automatically communicate with one or more repositories of digital image data, that may be connected to it via any suitable data-carrying line, including local or wide-area network connections, as known in the art. It may be regarded as a form of data connectivity module. The image repositories may comprise any special-purpose or general-purpose computer having a memory in which digital image data is stored. For example, in a health-care application, the image repositories may comprise one or more computers running a health-care office's imaging applications. There may be as few as a single repository, or numerous different repositories storing images in numerous image data protocols, connected to the same image-source liaison component of the unified imaging sub-system. An image repository essentially comprises a database containing digital data defining at least one image. The image-source liaison component may comprise a computer running application software according to the invention, having suitable connections to the image library component and image repositories as referenced above.

In a zero-footprint mode, the image-source liaison may be provided with a profile for each connected image repository, for which it is to act as a liaison. Each profile may describe its respective image repositories' network parameters, image format, image-associated data format, and any other information needed to automatically locate and upload image data from the repository. Each profile need only be provided once, when the connection to the image-source liaison is first made, although it may be updated as needed. As part of an initial setup, or in the alternative, periodically as needed, the image-source liaison may be provided with the necessary permission from each respective image repository, so as to permit direct access to image data and associated data located in the repository. For example, security information may be included in the profile. The image-source liaison may use the profile and its connection to the repository to periodically locate and upload image data, and any associated data, to the image library component. The liaison may be configured to operate automatically, without any disruption of normal operations of the image repository. For example, in a busy medical office, after the initial setup, an imaging terminal may be operated exactly as if there were no connection to the liaison component, insofar as the person operating the terminal is concerned. Meanwhile, images may be automatically uploaded to the library component via the liaison. Manual uploading of image data may also be. facilitated, if desired.

In addition, or in the alternative, one or more image-source liaison components of the system may be configured to operate in a non-zero footprint mode. For example, specialized software may be installed on an image repository, which periodically sends image data to an associated image-source liaison or directly to the image library. As in zero-footprint mode, sending of data may be accomplished automatically using a method initiated by the image-source liaison, or manually at the user's request.

The image library component may be configured to function as a central repository, gatekeeper, and data processing engine for both image and profile data. As such, it may comprise both database and substantial processing engines. Such profile data may include not only high-level profiles for image repositories, but also profiles for viewing hardware and/or software used by end users who are interested only in viewing images. A high-level profile may be regarded as a profile that is true for a group of image repositories. For example, such a profile may define profile information that is common to all “Brand X” imaging machines, or to all instances of a network browser application, in both cases with respect to a specific version. A profile may define, among other things, which image protocol(s) are compatible with particular computer resource, the location where images and other data are stored on image repositories, and communication and security protocols. The profile database is thus a scaleable and upgradeable connectivity tool for the exchange of images and associated data.

The image library component may also function as a server and manager of other image-associated data, for example, patient data as disclosed in the parent application. The library component should also function to control access to image data, so that images are only distributed to qualified persons, wherein qualifications are determinable using image-associated subject data. The library component may also provide related functions, such as creating and maintaining audit trails to record which images were viewed by which persons, and when. A further function of the library component may be to translate images between various data protocols, managing and maintaining a database of images in both native and translated data protocols, general system maintenance and administration, and other centralized functions. Any suitable computer server, or group of connected servers, may be configured to function as a library component by installation of a suitable software application.

Image-associated data may be provided to a database using various methods as known in the art. For example, in the health care context, a data entry method may make use of a patient-operated data entry interface, such as an interactive form for gathering health history, insurance, address, and other patient data. A terminal for making forms accessible to patients may be provided, for example, in a waiting room, and/or forms may be accessed remotely using the provider's web site. In embodiments of the invention, image-associated data comprises an identifier for the subject or subjects imaged in the associated image. For example, in a health care context, the identifier may comprise a patient name, ID number, image date, and/or other suitable identifying information. For further example, in a more general context, a subject identifier may comprise a subject name, date, location, and/or other information for identifying the subject or subjects appearing in the image.

The system components may be further configured to permit interaction with legacy database systems, such as practice management or other data systems, so that image-associated information that has been collected in the past (for example, patient information) can be provided to authorized requesters without any new data entry. Systems for collecting data from legacy databases are further described in the parent application. Such a system may comprise, for example, a liaison component on a computer co-located with legacy database systems, which functions to extract relevant data (for example, in the health care context, health histories, health status, appointment and account information) from the legacy database. The extracted information may be periodically uploaded to a web server, e.g., on demand, when scheduled, or each night. Any suitable system for interfacing with a variety of legacy systems may be adapted to also interface with a variety of different image data protocols, as described herein.

Confidential data may be protected with a high degree of security, for example, by password protected screens and browsers, using security and encryption, on secure domain web sites, as known in the art. More particularly, access to images may be controlled using image subject identifiers to link one or more related images to qualified requesters. For example, requesters providing an authentication code associated with a subject may be provided access to images associated with that subject's identifier. A subject identifier may include sufficient information to permit controlling access to subsets within a related group of images. For example, a subject identifier may comprise numerous components with any desired degree of dependency, such as “ABC,” wherein each letter represents a component. Authentication codes may then be linked to one or more components, which may be related in a hierarchical fashion. Using such a system, for example, a patient may be provided an authentication code permitting access to all images of the patient, while the patient's dentist may be provided with a code that is linked to a dental images component, permitting access only to the patient's dental images.

The system may store image and other data using at least one database, for example, through an open connectivity module. Images and associated data may be requested using any suitable query, which may be formulated using a graphical query input interface as known in the art. For example, a web page coded in HTML, XML, or any other suitable language may be used. The security status of the requestor may be verified using any suitable method, as known in the art. The system then presents data from one or more selected data fields to a recipient in accordance with one or more objects or templates.

The system may provide a tools repository, such as a web based tools repository, which may reside in one or more databases. The tools repository may include objects, forms, templates, applets, image translation or other image processing tools, image viewing tools, or other software tools. The system may be configured to select a suitable tool, depending on the image(s) and other data requested by a query. Image and other data may be provided to the requested destination for presentation to the user using an appropriate tool. Presentation tools may be configured to ensure secure transmission of confidential data and, if desired, to prevent copying of such data to a less secure format.

The following example may serve to illustrate operation of a system according to the invention, in a health-care environment. Doctor Jones uses brand “X” practice management and imaging software, in a system connected via an image-source liaison to an image library of a system according to the invention. Doctor Smith, a specialist to whom Doctor Jones refers patients, uses brand “Y” practice management and imaging software, which, as it happens, is not connected to a system according to the invention. However, Doctor Smith does have a internet connection and web browser that is used in a conventional fashion.

Suppose Doctor Jones acquires an image of a patient Doe, and then refers Doe to Doctor Smith for specialty treatment. To make Doe's image and other data available to Doctor Smith, Doctor Jones merely sends (for example, by secure email) an authentication code to Doctor Smith, with instructions for accessing the data at via a designated website. Doctor Smith then supplies the code to the website, which provides the image and associated data for display and/or use in a compatible database. Doctor Smith does not need to have any special software to view the image. If the image is not available in a format that Doctor Smith can use, the system website may supply a platform-independent, distributable application, such as a JAVA applet, for use in viewing.

In addition, if Doctor Smith is impressed with the image management system, and desires to use it to share images with other doctors, the fact that Doctor Smith uses different imaging or practice management software from Doctor Jones or other doctors presents no barrier. When Doctor Smith connects her imaging system to an image collection and distribution system according to the invention, the system automatically acquires Doctor Smith's images in a manner compatible with Brand “Y” systems, and handles any necessary conversions for other doctors to view those images. Thus, the invention provides a powerful tool for collaboration between different doctors, including rapid and convenient sharing of diagnostic data with minimal administrative overhead and maximal flexibility and openness to different image data protocols.

A more complete understanding of the invention will be afforded to those skilled in the art, as well as a realization of additional advantages and objects thereof, by a consideration of the following detailed description of the preferred embodiment. Reference will be made to the appended sheets of drawings which will first be described briefly.

### BRIEF DESCRIPTION OF THE DRAWINGS

FIG. 1 is a diagram showing an exemplary web-connected system according to an embodiment of the invention.

FIG. 2 is diagram showing exemplary software and application elements of the system of the invention.

FIG. 3 is a diagram showing an exemplary embodiment of a system for collection and distribution of image data according to an embodiment of the invention.

FIG. 4 is a screen shot showing an exemplary presentation of various images as may be collected and distributed to a dentist.

FIG. 5 is a screen shot showing an exemplary presentation of various images as may be collected and distributed to an insurer.

### DETAILED DESCRIPTION OF THE PREFERRED EMBODIMENT

The invention provides a system and method for the collection and management of image data in disparate data protocols and from different sources, and distribution of such image data to qualified recipients, that overcomes the limitations of the prior art. In the detailed description that follows, like numerals are used to describe like elements appearing in one or more of the figures.

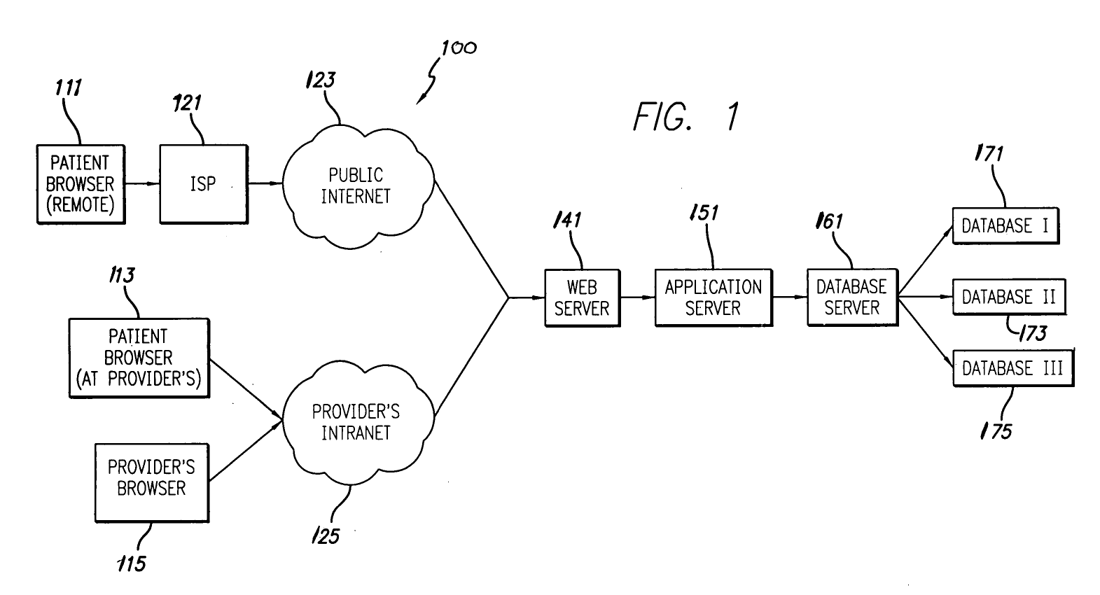

FIG. 1 illustrates a system 100 topography useful in the practice of a method and system of the invention, according to an embodiment for handling medical information. Such systems may be adapted or used in conjunction with systems for collecting and distributing image data as more fully described below. System comprises a plurality of web browsers, e.g., 111, 113, 115. One browser 111 is connected through an internet service provider 121 to and through the public internet 123 to a web server 141. Browsers 113 is accessible to patients at the provider's site, and browser 115 is for the individual provider's use at the provider's site, and connected to and through the provider's intranet to the web server 141. Web server 141 may comprise conventional web server capabilities and functionalities. The web server 141 is in communication with an application server 151, which, in turn, is in communication with a database server 161. The database server 161 interacts with one or more databases, 171, 173, and 175. At least one of the databases may be a tools repository that has objects and applets specific to the method and system described herein, for distribution over internet 123 and/or intranet 125.

While only two office-based terminals, 113 and 115 on LAN or intranet 125 are shown, it should be apparent that the method and system of the invention is amenable to networking multiple offices in the same practice. For example, a connection may be made to and through the web or corporate intranet 125 from a terminal 113 or server in one location via intranet 125 and/or internet 123 to application servers, web servers and data servers in another location, such as a satellite office. In this way, the method and system facilitates uploading data from a ciient's server in a main office to a server having the web server 141, application server 151, and data server 161, and from there downloading the data to satellite offices.

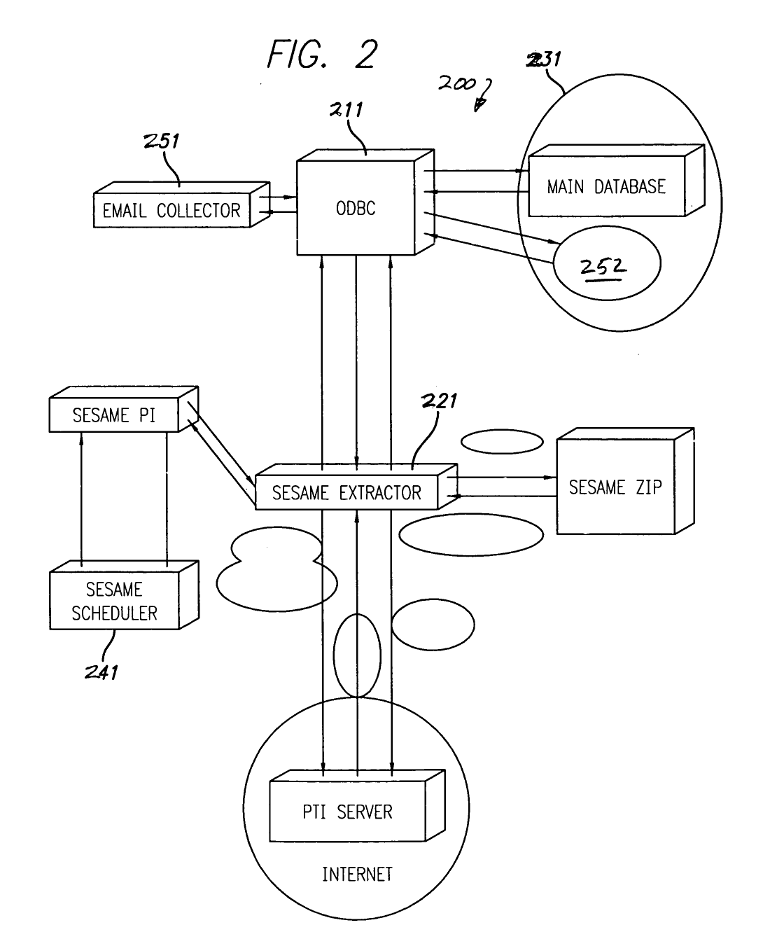

FIG. 2 illustrates the interaction of software elements in a scalable module 200 of the method and system of the invention. The illustrated example of the system and method includes a database connectivity module, such as the open database connectivity module (ODBC) 211, for accessing a variety of databases. By using the structure and syntax of ODBC 211, or a similar tool or application, the user can access files in a number of different databases from various vendors, including legacy databases using the same statements in a program. In addition to ODBC 211,, a separate connectivity module or driver is used for each database to be accessed.

Although method and system is described and illustrated with respect to ODBC, it should be apparent that other connectivity modules offering similar functionality may also be used. ODBC is based on and closely aligned with the Open Group standard Structured Query Language (SQL) Call Level Interface. In this way, SQL requests may be used to access database content without knowing the proprietary interfaces to the databases. ODBC handles the SQL request and converts it into a request the individual database system understands.

ODBC 211, or other application, solution, or functionality, provides an interface between one or more databases, shown in FIG. 2 as the main database 231, tools database 252, and the other modules. One such module, linking the database connectivity module 211 to the outside world and to other modules, is the sesame extractor, 221. Extractor 221 interfaces with the basic database 231 and performs necessary data extraction and data recording in a designated data protocol. Extraction may include, for example, storing extracted data according to the designated data protocol for periodic transmission to main database 231. The extractor may also perform utility functions such as text file compression, file transfer to the server, and analysis and file transfer of database entries from data sources (patients, referred providers) to the provider. Another function of the extractor may comprise providing high performance CGI using an HTTP connection. The Extractor may comprise, for example, a multithreaded Windows™ dialog-based application.

Other aspects of the system 200 may include a scheduler, 241, and a data collector or an email collector, 251. The email address collector module, 251, also referred to as a collector module 251, allows users, such as patients or customers, enter their own email addresses, thereby eliminating such data entry by staff. Additionally, collector 251 may be configured to perform functions such as: (a) checking the identity of the user, using identifying information including birth date, social security number or other identifying numbers to establish a perfect match with the individual in the database; (b) prompting for complete spelling of first, last name, birth date, social security number, name of provider, etc. if data entry errors are indicated; (c) accepting multiple email addresses for a single record, and sorting these addresses according to specific parameters (for example, addresses identified as belonging to “Mother” will receive billing notification, while an email address belonging to an underage patient will not); (d) associating email addresses with specific records in the database; (e) assigning and/or recording user-originated personal identification numbers (PINS); (f) facilitating user-requested changes of personal data.

Although the collector 251 is illustrated as an email address collector in the context of health care, it should be apparent that it has applicability in other contexts. Collector 151 may be used to collect end-user data for any application having a need to gather personal data for records in a database. Collection and use of non-image data is further discussed in the parent application, the inventive concepts of which may be adapted and combined with those newly disclosed herein to provide a system and method for collection and distribution of both image data, and non-image data. A more detailed description of an image data collection and library system is provided below.

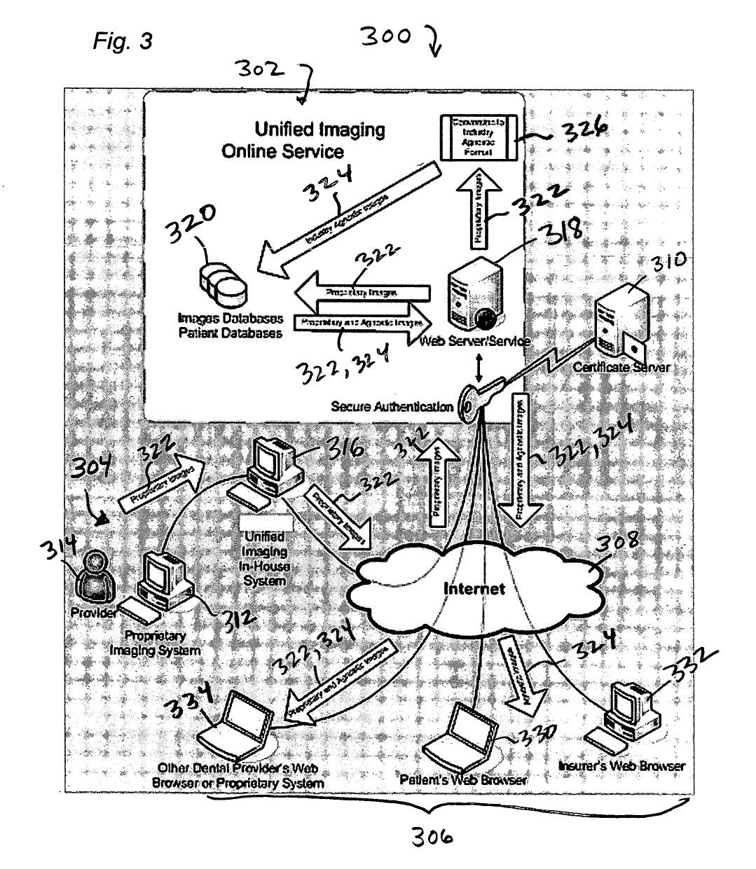

Referring to FIG. 3, an exemplary system 300 according to the invention is disclosed. Although FIG. 3 includes examples from a health care context, the invention is not thereby limited. System 300 includes a library component 302, a plurality of client repositories 304 (one of many shown), and a plurality of image viewing clients 306, connected via a wide area network 308. Transmissions to the library component 302 may be secured and encrypted as known in the art, such as by using a certificate server 310.

Client repositories 304 may include a proprietary imaging system 312 operated by a provider 314, who is responsible for collecting a image of the subject, correctly associating the image with an identifier for the imaged subject matter, and securely maintaining the image in storage. In heath care, an image may comprise, for example, any visual capture or model of a patient's body or diagnostic measurements thereof, whether still, animated, 2-D, or 3-D. Such images may include, for example, photographs. x-rays, tomograms, computerized axial tomography (CAT) scans, magnetic resonance images (MRI's), videos, animations, and models such as EModel™, Orthocad™, and RxDDS™. The foregoing examples are not intended to limit the invention, but to illustrate the wide diversity of disparate image protocols already present in certain applications, which plainly present a substantial barrier to the exchange of digital image data.

To add further to the complexity of image exchange, different standards (whether formal or informal) may apply to the images that are to be exchanged. For example, in health care, images used in the diagnosis and treatment of disease should be of clinical quality or better, meaning that the image should be of sufficient quality to enable independent clinical analysis and diagnosis. Images of less than clinical quality may be useless to the clinician, or worse still, may be a factor causing misdiagnosis. However, many images do not need to be of clinical quality, for example, images used in communicating with patients or insurers to illustrate the general nature of the disease and its treatment. Such images may be referred to as being of communicative quality. Generally, clinical-quality images consume much more bandwidth than communicative-quality images. For example, data required to digitally store an image is roughly related to the square of its resolution (such as measured, for example, in pixels per inch), and high-quality images are usually high resolution. In addition, high-quality images may also have greater color depth, dynamic range, frames per second, or other qualities that consume digital information resources. Therefore, high-quality images impose much higher bandwidth requirements on system 300. One of the functions of system 300, therefore, should be to safeguard the quality of images when necessary, while making use of lower-quality analogs when it is desirable to reduce bandwidth requirements.

Repositories 304 may also include image databases that are maintained by the image provider 314. For example, a general-purpose computer may be used to store images received from a imaging system or images digitized from analog media such as film. Connectivity to client repositories 304 may be achieved via a corresponding plurality of liaison components 316. Each repository may have a liaison 316 installed locally on a computer connected to one or more imaging systems 312, as diagrammed in FIG. 3. In the alternative, or in addition, the liaison may be installed on the imaging system 312, distributed over network 308 from library 312 or other network server, and/or run as a remote application on library 312 or other server.

The liaison component 316 and client repository 304 may interact together in various operating modes. In a zero-footprint mode, the liaison component 316 may periodically connect to the repository and automatically extract images and associated data for transmission to library component 302. After initial installation, the liaison may perform virtually all of the administrative overhead, including but not limited to authentication, encryption, image selection, and communication, as needed for the collection of images in the library. The zero-footprint mode may be advantageous in easing burdens both on the provider 314 and library 302. In the alternative, or in addition, system 300 may also include feeder repositories that “feed” provider-selected images to the library under the control of provider 314, instead of having the images automatically extracted by a liaison component. This may be accomplished, for example, by defining a secure communications protocol for interfacing with a consumable web service offered by library 302, and providing the protocol to an applications developer. An image repository may thereby be developed under the control of an image provider, that uploads qualified images to library 302 via secure internet communications after the source is authenticated, e.g., by password authentication. Liaison component 316 of system 300 may be configured to communicate with and extract data from a variety of legacy databases, including Access databases, Unix, and even DOS based systems, thereby increasing the range of image repositories suitable for connection to system 300.

System 300 therefore provides for collection of native images 322, which may be provided in any digital image data protocol determined by the image source, e.g., imaging system 312. Such protocols may be proprietary to a particular imaging system developer, and/or publicly available protocols. If system 300 detects imaging data in a protocol that is new or unrecognized, library 302 or liaison 316 may consult a database of protocol profiles for a matching profile. If no matching profile is available, system 300 may generate and transmit an appropriate message to a system administrator, to expedite the addition of a suitable profile to the profile database. In the alternative, or in addition, each client repository that is newly added to the system or updated with imaging software may be individually tested at the time of installation or update, to ensure compatibility with system-recognized image protocols.

Library component 302 may comprise one or more servers 318, and a plurality of databases (or a single integrated database) 320. Database(s) 320 may include a database for native images 322, which are stored in association with an identifier for the image subject. For example, the identifier may include a patient name, birth date, image date, and identification of the body part that is imaged (e.g., upper occlusal, right kidney, etc.). A provider identifier may also be stored in association with the image. These identifiers (subject and provider) may be used to determine access rights to an image or group of images. For example, a password distributed from the library component 302 or other system computer may be used to designate access to all, or to a designated subset, of images in the library that pertain to a designated subject.

Database(s) 320 may further include other data of interest to the overall end use served by system 300, for example, patient data as described more fully in the parent application. In addition, or in the alternative, database(s) 320 may include tools for use in overall system operation, for example, distributable applets and objects for viewing and entering images and/or other data on various hardware and software platforms. Protocol profiles, for example, may also be regarded as a sort of system tool for storage in a centralized location, to be distributed as needed to image source repositories 304 or image viewing clients 306.

To conserve bandwidth when possible, it may sometimes be desirable to translate higher-quality images to a lower-quality format. In addition, some native images 322 may be collected in a proprietary data protocol that is not available to some users of the system. It is desirable to translate such images to a publicly-available protocol that can be viewed using widely-distributed applications and/or readily distributable tools from database(s) 320. For the forgoing purposes, library 302 may translate some or all native images 322 to one or more publicly-available data protocols, typically of communicative quality and therefore consuming less bandwidth, using any suitable translation process 326. For example, images may be translated to an industry-agnostic protocol, which is a protocol commonly supported by virtually every browser, image viewer, player and/or imaging software. Examples may include JPEG, MPEG, GIF, TIFF, PNG, and other new or revised protocols such as are now or which become widely accepted and supported. Such protocols may include any suitable protocol that is widely accepted and supported, whether or not it is technically considered a “standard.”

Images may also be translated to any other formats of equal or lower quality as the native image. For example, a native clinical-quality image in a first protocol may be translated into a second protocol of equal image quality, such as for viewing or analyzing using a second proprietary imaging system. Although this may not reduce bandwidth requirements, it makes the library images more accessible and/or useful to system clients. Methods for providing image protocol translation processes 326 are known in the art, and/or may be readily developed by one of ordinary skill. Translated images 324 may be stored with native images 322 in database(s) 320.

Image viewing clients 306 may comprise conventional network clients running widely-available web browser software, for example, a patient browser 330 and an insurer's browser 332. Such clients may generally be served translated images 324. Details of conventional browsers are well understood in the art. Clients 306 may further include a proprietary system client 334, for example, a health care provider's computer operating proprietary image-viewing software. Client 334 may also operate conventional viewing software. Client 334 may be served both native images 322 and translated images 324, as desired. Clients may connect to library 302 and access images using conventional web browsers and authentication methods.

In an embodiment of the invention, system 300 may be configured to provide a consumable web service to an authenticated client application. Such as web service should have a defined common interface, permitting bidirectional exchange of images and associated data with external clients. This should be especially useful for clients that operate both as image providers and as consumers. The consumable web service permits the independent development and operation of the client imaging operation, while permitting exchange of images to and from library 302 and the external imaging operation.

System security and data security may be of particular importance in web-based image collection and distribution systems, for example, in health care contexts. As noted in the parent application, security requirements may exceed what can readily be provided using conventional identification codes and passwords, encryption, and secure socket layers. It may be desirable in some embodiments of system 300 to employ actual access blocking. To implement access blocking, an image-associated file or data may include a field or fields indicating blocking and access, with an enumeration of classes of users or even individual users who may have access to the record. Such access rules may also take into account the image subject identifier that is associated with each image. For example, a “Block/Unblock” option may be provided, which allows the user to restrict access to a particular file. Such an option may be useful, for example, for a provider with patients who request that their information not be on the Web. Selection of a “block” option at a provider interface may operate to prevent serving of an image from the image library, and/or to prevent collection of the image in the library in the first place.

In general, software for system 300 may be provided in various languages, including, for example C++. System 300 may use tools and applications such as ODBC to access the provider's database and extract the data, and automatic dial-up and/or FTP to upload data to our server. Transferred data may be stored in any suitable database, such as, for example, a MySQL database. The database may be located on the web server(s) 318 or on a separate remote server. Access to the data be provided by, for example, Perl CGI scripts. The web-integrated information in library 302 may be made available to users on password-protected pages from secure web sites that are scalable, configurable, and customizable for each image provider. For example, doctors of different practice types may customize a suitable web site for patient interface using web site templates developed for the plurality of image providers. Such web sites may be located and served from server(s) 318 or other network location.

In general, it should be apparent that any suitable library component 302, when connected to other elements of system 300, may be used to perform various methods according to the invention. For example, the library may perform a method that includes the steps of:
(a) connecting to a plurality of client repositories, wherein the client repositories contain digital image data arranged according to various user-selected data protocols;
(b) collecting images and subject data from the client repositories, wherein the images comprise the digital image data and the subject data comprises identifiers for subjects imaged by the images;
(c) storing the images in association with the subject data in an image library connected to a wide area network, so that each stored image is associated with an identifier for a respective imaged subject; and
(d) selecting authorized ones of the stored images for responding to requests using the subject data.

This exemplary method may comprise an important portion of the steps and processes carried out by library 302 during system operation, without which many advantages described in the instant application would not be realized. These steps may be varied and/or combined with other steps as suggested by the instant application, or as should be apparent to one of ordinary skill. For example, the above connecting step (a) may further comprise connecting to the plurality of client repositories via a plurality of liaison components, each associated a different one of the client repositories, as explicitly described above. For further example, the collecting step (a) may further comprises automatically collecting the images and subject data using the plurality of liaison components. One of ordinary skill will be able to construct a suitable library 302 capable of performing these and other steps of the invention.

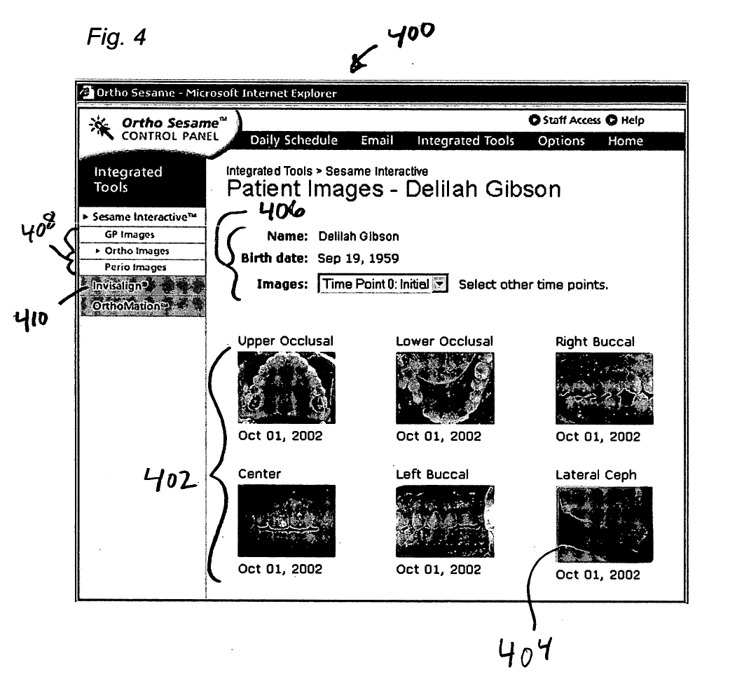

Some examples may by helpful to further illustrate the benefits and operation of system 300 and methods performed therewith. FIG. 4 shows an exemplary web browser screen shot 400, on which a plurality of images 402 are displayed in a communicative-quality protocol. Image 404 is an x-ray collected in a disparate protocol from the other images 402. All of the images are associated with the subject identifiers listed on the web page. Links 408 to images in other subcategories relating to the same patient are provided at upper left. A link 410 to an interface for viewing, editing, and entering other patient data as more fully described in the parent application is also provided. A patient or other user may view page 400 by logging on to a portal page for library 302, and entering an authentication code supplied by the provider or directly from system 300. Page 400 may be automatically created by system 300 after patient and associated image data are collected from one or more image providers.

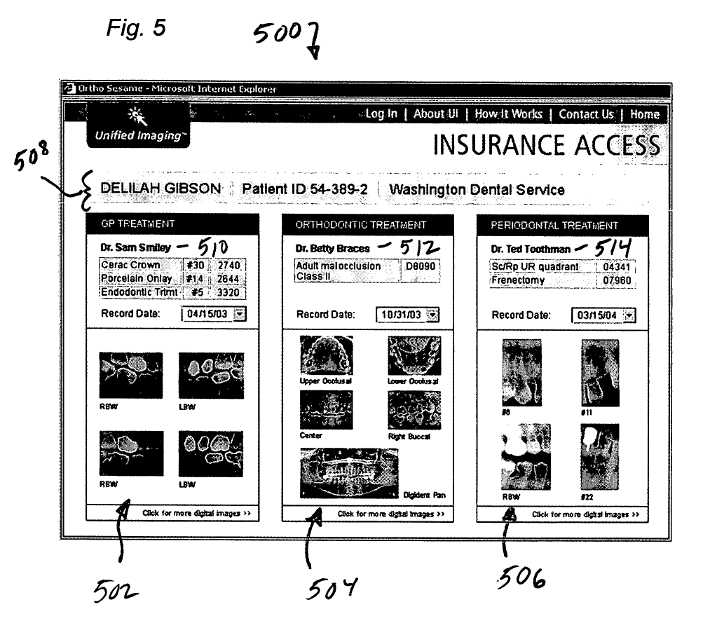

FIG. 5 shows another exemplary page 500, on which images 502, 504, 506 of communicative quality from different providers are displayed on a single page. Subject identifiers 508 are also displayed, from which it is clear that all of the images relate to a single subject. The identifiers 510, 512, 514 for different image providers are also displayed. Although the page is titled “insurance access,” multi-provider display modes are not limited to a particular class of users, although insurers may find such displays useful. The exemplary page illustrates but one application for the collection and distribution of images from disparate sources according to the invention.

Having thus described a preferred embodiment of a system and method according to the invention, it should be apparent to those skilled in the art that certain advantages of the within system have been achieved. It should also be appreciated that various modifications, adaptations, and alternative embodiments thereof may be made within the scope and spirit of the present invention. For example, a particular distribution of functions over connected network resources has been illustrated, but it should be apparent that the inventive concepts described above would be equally applicable to various different way of distributing the same functions over different nodes of a network. For example, and not by way of limitation, image-source liaison functions may be distributed over several different computers, including other components such as image repositories or libraries, or located on a single discrete computer. Furthermore, the invention is not limited to a particular type of computer, network, operating system, or the like, and may be adapted for implementation with various different computer hardware and software by one of ordinary skill in the art. Furthermore, although the parent application and most of the examples herein primarily concern image collection and distribution for health-care applications, the invention is not limited to any particular source or end use for image data. The invention is defined by the following claims.

1. A method for collecting and distributing image data across multiple image data protocols over a wide area computer network, the method comprising:
connecting to a plurality of client repositories, wherein the client repositories contain digital image data arranged according to various user-selected data protocols;
collecting images and subject data from the client repositories, wherein the images comprise the digital image data and the subject data comprises identifiers for subjects imaged by the images;
storing the images in association with the subject data in an image library connected to a wide area network, so that each stored image is associated with an identifier for a respective imaged subject; and
selecting authorized ones of the stored images for responding to requests using the subject data.

2. The method of claim 1, wherein the connecting step further comprises connecting to the plurality of client repositories via a plurality of liaison components each associated a different one of the client repositories.

3. The method of claim 2, wherein the collecting step further comprises automatically collecting the images and subject data using the plurality of liaison components.

4. The method of claim 3, wherein the collecting step further comprises collecting the images by communicating over the wide area network with the plurality of liaison components, wherein the liaison components comprise computers running database connectivity applications, respective ones of the computers co-located with respective ones of the plurality of client repositories.

5. The method of claim 1, wherein the connecting step further comprises connecting to the client repositories, wherein the various user-selected data protocols require respectively different data bandwidths in relation to respective supported image qualities.

6. The method of claim 5, further comprising translating an original image collected in a first image data protocol to a translated image in a second image data protocol.

7. The method of claim 6, further comprising storing the translated image in the image library in association with subject data for the original image.

8. The method of claim 6, wherein the translation step further comprises selecting the second image data protocol to be viewable using an image viewing application that is widely supported over the wide area network.

9. The method of claim 6, wherein the translation step further comprises selecting the second image data protocol having a bandwidth requirement substantially lower than the first image data protocol.

10. The method of claim 6, wherein the translation step further comprises selecting the second image data protocol to result in an image of communicative quality, while the first image data protocol results in an image of clinical image quality.

11. The method of claim 6, wherein the translation step further comprises selecting the second image data protocol to be viewable using a different viewing application than used to view images in the first image data protocol, without degradation of image quality.

12. The method of claim 1, further comprising maintaining a profile for each of the various user-selected data protocols in a profile database connected to the wide area network.

13. The method of claim 12, further comprising determining whether images are in a data protocol that is profiled in the profile database.

14. The method of claim 13, further comprising adding a new profile to the profile database when image data is collected that is not in a profiled data protocol.

15. The method of claim 1, further comprising providing a distributable application for viewing images in response to requests for selected ones of the images in the image library.

16. The method of claim 1, further comprising maintaining a database of authentication codes in association with the subject data, and providing ones of the authentication codes as passwords for accessing associated ones of images in the image library.

17. The method of claim 1, further comprising associating a highest-level authentication code with a person identified by the subject data, and providing lower-level access images associated with the person's subject data to others designated by the holder of the highest-level authentication code.

18. The method of claim 1, wherein the responding step further comprises transmitting a web page including at least one requested image to a requested network address.

19. The method of claim 1, wherein the responding step further comprises streaming video data including at least one requested image to a requested network address.

20. The method of claim 1, further comprising providing a consumable web service for bidirectional exchange of images with an independent client application.
